(19) United States
(12) Patent Application Publication
(10) Pub. No.: US 2014/0351003 A1
(43) Pub. Date: Nov. 27, 2014

(54) SYSTEM AND METHOD FOR COMPUTATION OF VALUE REALIZATION INDEX

(71) Applicant: Tata Consultancy Services Limited, Mumbai (IN)

(72) Inventors: Hari Prasad DEVARAPALLI, Hyderabad (IN); Narayana Guru Prasada Lakshmi MANDALEEKA, Hyderabad (IN)

(73) Assignee: Tata Consultancy Services Limited, Mumbai (IN)

(21) Appl. No.: 13/901,261

(22) Filed: May 23, 2013

(51) Int. Cl. G06Q 30/02

(52) U.S. Cl. CPC G06Q 30/0201
USPC 705/7.29

(57) ABSTRACT

System and Method for computing a value realization index for Information Technology (IT) services is disclosed. According to the system and the method, a data receiving module may be configured for receiving input data indicative of monetary value invested by a use on the IT services. Further, computational weights for qualities associated with the IT services may be received from the user. A data normalization module may be configured for normalizing the computational weights. A metric capturing module may be configured for capturing quality metrics for the qualities and the business metrics for the IT services. A metric mapping module may be configured for mapping the quality metrics with the business metrics using the normalized computational weights and domain benchmark values. A derivation module may be configured for deriving a business value. An index computation engine may be configured for computing the value realization index for the IT services.

### TECHNICAL FIELD

The present subject matter described herein, in general, relates to Information Technology (IT) systems, and more particularly to a system and method for computing a value realization index (VRI) for Information Technology (IT) Services.

### BACKGROUND

IT sector has witnessed enormous growth in the last few decades. The Information Technology sector includes an IT vendor capable of delivering IT services to customers across the globe. The IT services delivered by the IT vendor mainly include application development services, application testing services, application maintenance services and technology consulting services. The IT services delivered by the IT vendor may result in generation of a business value. Generally, the business value of any organization is computed quantitatively based on Return on Investment (ROI). However, the ROI method fails in scenarios where it is impossible to convert directly the aspects of the business into monetary value. Specifically, in IT services, at many instances it becomes difficult to convert the aspects of IT services in terms of dollars, and hence applying the ROI method may not be possible.

Another way of obtaining a value of the IT services is by accepting input data from the users of the IT systems. The input data may be key performance indicators (KPIs) of the IT services. However, there exists a technical challenge of computing the value of the IT services using the input data due to its differential, unstructured, and dynamic nature. Further, there exists a technical challenge of aligning the multiple individual key performance indicators of the IT services associated with the input data amongst each other that may be critical in computing the value for the IT services. Thus, there is a need for a solution that addresses challenges observed in computation of the value of the IT services due to dynamic nature of the input data and the issues with traceability of individual KPIs associated with the IT services.

### SUMMARY

This summary is provided to introduce aspects related to systems and methods for computing a value realization index for one or more IT services and the aspects are further described below in the detailed description. This summary is not intended to identify essential features of the claimed subject matter nor is it intended for use in determining or limiting the scope of the claimed subject matter.

In one implementation, a system for computing a value realization index for one or more IT services is disclosed. The IT services may be implemented in a framework deployed at an organization. The system may include a processor and a memory coupled to the processor wherein the processor is capable of executing a plurality of modules. The plurality of modules may include a data receiving module, a data normalization module, a metric capturing module, a metric mapping module, an identification module, a validation module, a derivation module and an index computation engine. The data receiving module may be configured to receive a first input data indicative of a monetary value invested by a user on each of the one or more IT services. Further, the data receiving module may be configured to receive a second input data indicative of one or more computational weights for one or more qualities associated with the one or more Information Technology (IT) services. The data receiving module may be configured to receive a third input data indicative of a second set of computational weights, transaction volume and cost associated with one or more business metrics of the one or more qualities. The first input data, the second input data and the third input data may be received from the user. The data normalization module may be configured to normalize the one or more computational weights at a level of the organization. The normalization of the one or more computational weights may result in generation of the one or more normalized computational weights for the one or more qualities. The metric capturing module may be configured to capture one or more quality metrics for the one or more qualities and one or more business metrics for the one or more IT services. The metric mapping module may be configured to map the one or more quality metrics with the one or more business metrics by considering the one or more normalized computational weights, the third input data and domain benchmark values. The identification module may be configured to identify scope for improvement for each of the one or more qualities based on the result of the mapping in a manner such that, the scope for improvement identified exploits one or more business opportunities to the organization. The validation module may be configured to validate the one or more business opportunities exploited in context of the scope for improvement identified based on said mapping. The derivation module may be configured to derive a business value for the organization based on the one or more business opportunities exploited in context of the scope for improvement identified for the one or more qualities. The index computation engine may be configured to compute the value realization index for the one or more IT services at a level of at least one of the user and the organization. The value realization index may be computed based on the business value derived and the first input data received from the user.

In another implementation, a method for computing a value realization index for one or more Information Technology (IT) services is disclosed. The IT services may be implemented in a framework deployed at an organization. The method comprises a plurality of steps performed by a processor. According to the method, the processor may initially perform a step of receiving from a user: a first input data indicative of a monetary value invested by the user on each of the one or more IT services, a second input data indicative of one or more computational weights for one or more qualities associated with the one or more IT services and a third input data indicative of a second set of computational weights, transaction volume and cost associated with one or more business metrics of the one or more qualities. The processor may then perform a step of normalizing the one or more computational weights at a level of the organization to generate one or more normalized computational weights for the one or more qualities. Further, the processor may perform a step of capturing one or more quality metrics for the one or more qualities and one or more business metrics for the one or more IT services. The processor may then perform a step of mapping the one or more quality metrics with the one or more business metrics by considering the one or more normalized computational weights, the third input data and domain benchmark values. The processor may further perform a step of identifying scope for improvement for each of the one or more qualities based on said mapping in a manner such that, the scope for improvement identified exploits one or more business opportunities to the organization. The processor further performs a step of validating the one or more business opportunities exploited in context of the scope for improvement identified based on said mapping. The processor may further perform the step of deriving a business value for the organization based on the one or more business opportunities exploited in context of the scope for improvement identified for the one or more qualities. Finally, the processor may perform a step of computing the value realization index for the one or more IT services at a level of at least one of the user and the organization. The value realization index may be computed based on the business value derived and the first input data received from the user.

In yet another implementation, a computer program product having embodied thereon a computer program for computing a value realization index for one or more Information Technology (IT) services is disclosed. The IT services may be implemented in a framework deployed at an organization. The computer program product may include a program code for receiving a first input data indicative of a monetary value invested by a user on each of the one or more IT services, a second input data indicative of one or more computational weights for one or more qualities associated with the one or more IT services and a third input data indicative of a second set of computational weights, transaction volume and cost associated with one or more business metrics of the one or more qualities. The first input data and the second input data may be received from the user. Further, the computer program product may include a program code for normalizing the one or more computational weights at a level of the organization to generate one or more normalized computational weights for the one or more qualities. The computer program product may include a program code for capturing one or more quality metrics for the one or more qualities and one or more business metrics for the one or more Information Technology (IT) services. The computer program product may also include a program code for mapping the one or more quality metrics with the one or more business metrics by considering the one or more normalized computational weights, the third input data and domain benchmark values. The computer program product may further include a program code for identifying scope for improvement for each of the one or more qualities based on said mapping in a manner such that, the scope for improvement identified exploits one or more business opportunities to the organization. The computer program product may further include a program code for validating the one or more business opportunities exploited in context of the scope for improvement identified based on said mapping. The computer program product may further include a program code for deriving a business value for the organization based on the one or more business opportunities exploited in context of the scope for improvement identified for the one or more qualities. The computer program product may further include a program code for computing the value realization index for the one or more IT services at a level of at least one of the user and the organization. The value realization index may be computed based on the business value derived and the first input data received from the user.

### BRIEF DESCRIPTION OF THE DRAWINGS

The foregoing summary, as well as the following detailed description of embodiments, is better understood when read in conjunction with the appended drawings. For the purpose of illustrating the disclosure, there is shown in the present document example constructions of the disclosure, however, the disclosure is not limited to the specific methods and apparatus disclosed in the document and the drawings.

The detailed description is described with reference to the accompanying figures. In the figures, the left-most digit(s) of a reference number identifies the figure in which the reference number first appears. The same numbers are used throughout the drawings to refer like features and components.

FIG. 1 illustrates an exemplary network implementation of a system for computing a value realization index for one or more IT services.

FIG. 2 illustrates the system, in accordance with an embodiment of the present subject matter.

FIG. 3 illustrates detailed working of the components of the system, in accordance with an embodiment of the present subject matter.

FIG. 3 (A) illustrates an example of mapping of the business metrics with the quality metrics, in accordance with an embodiment of the present subject matter.

FIG. 4 illustrates a method for computing a value realization index for the one or more IT services, in accordance with an embodiment of the present subject matter.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating one or more of its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

System(s) and method(s) for computing a value realization index for one or more Information Technology (IT) services are described. In one embodiment, the one or more Information Technology (IT) services are to be deployed in a framework of an organization. In an exemplary embodiment, the framework may be an IT-enabled framework located at the organization premises where the IT services may be implemented. Specifically, the one or more IT services may comprise at least one of Application Development, Application Maintenance, Business Process Outsourcing, IT consulting and combinations thereof. In one embodiment, a first input data indicative of a monetary value invested by a user on each of the one or more Information Technology (IT) services may be received from the user. Further, a second input data indicative of one or more computational weights for one or more qualities associated with the one or more IT services may be received from the user. Additionally, a third input data indicative of a second set of computational weights, transaction volume and cost associated with one or more business metrics of the one or more qualities may be received from the user. In one embodiment, the one or more qualities may comprise at least one of comprise reliability, performance, availability, efficiency, compatibility, maintainability, transferability suitability, and one or more sub-qualities of each of the one or more qualities. The one or more computational weights may be indicative of priority assigned to each of the one or more qualities depending on the requirements of the IT services. The one or more computational weights may be normalized at a level of the organization to generate one or more normalized computational weights. The normalized computational weights may represent aggregation of the computational weights received from the user, and wherein the normalized computational weights may be acceptable by the user.

Subsequent to acceptance of the one or more normalized weights by the user, one or more quality metrics for the one or more qualities may be received. In one example, the one or more quality metrics may comprise throughput, response time, mean response time, Mean Turn-around Time, CPU Utilization, Memory Utilization, Mean time between failures (MTBF), User support function consistency and Hardware environmental adaptability. In one embodiment, the one or more quality metrics may be associated with a current quality (Qc), a promised quality (Qp) and an actual delivered quality (Qd). Further, one or more business metrics for the one or more IT services may be received. The one or more business metrics may be indicative of the measured and estimated metrics expected by the organization for the one or more IT services. In one example, the one or more business metrics may comprise cost of resources, expenditure cost, revenue, profit and loss, and combinations thereof.

In one embodiment, the one or more quality metrics may be mapped with the one or more business metrics. The one or more quality metrics may be mapped with the one or more business metrics by considering the normalized computational weights, the third input data and domain benchmark values of the one or more IT services. In one example, the domain benchmark values may comprise cost, effort, revenue, profit margin, resources and net sales, market share, industry understanding, policy and regulation impacting the business performance, competition, and emerging business models driven by new technologies. The mapping may result in identification of scope for improvement for the one or more qualities. The identification of the scope for improvement may be done based on the normalized computational weights, and the comparison of the one or more quality metrics with the one or more business metrics as a result of said mapping. Further, the mapping may be implemented in a manner such that, the scope for improvement for the one or more qualities results in exploiting one or more business opportunities to the organization. The alignment of the scope for improvement for the one or more qualities with the one or more business opportunities may be validated. The one or more qualities exploited in context of the scope for improvement may derive a business value to the organization.

Subsequent to the derivation of the business value, the value realization index for the one or more IT services may be computed. Specifically, the value realization index may be computed based on the business value derived and the first input data received from the user. The value realization may be computed on at least one of the level of the user and the organization.

While aspects of described systems and methods for computing a value realization index may be implemented in any number of different computing systems, environments, and/or configurations, the embodiments are described in the context of the following exemplary system. Thus, the following more detailed description of the embodiments of the disclosure, as represented in the figures and flowcharts, is not intended to limit the scope of the disclosure, as claimed, but is merely representative of certain examples of presently contemplated embodiments in accordance with the disclosure.

The presently described embodiments will be best understood by reference to the drawings, wherein like parts are designated by like numerals throughout. Moreover, flowchart and block diagrams in the figures illustrate the architecture, functionality, and operation of possible implementations of systems and methods according to various embodiments of the present disclosure. In this regard, each block in the flowchart or block diagrams may represent a module, segment, or portion of code, which comprises one or more executable instructions for implementing the specified logical function(s).

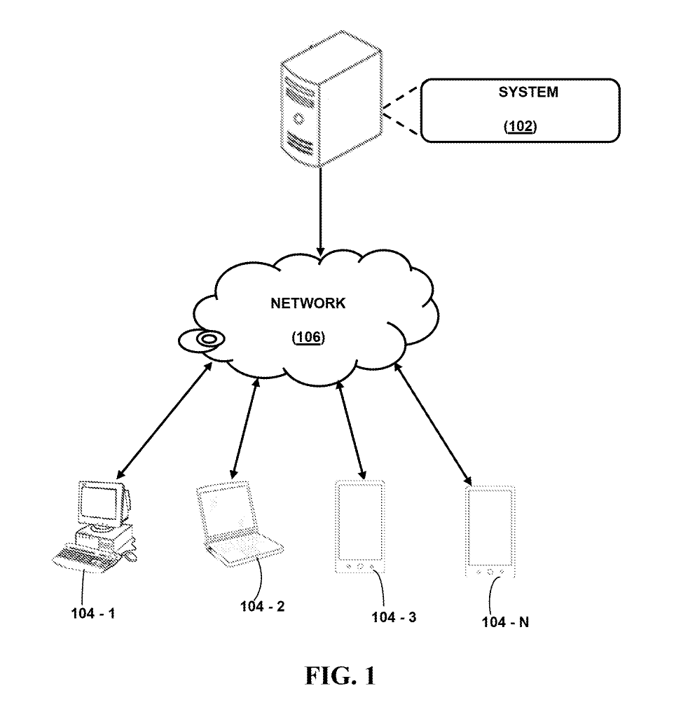

Referring now to FIG. 1, a network implementation of a system 102 for computing a value realization index is illustrated, in accordance with an embodiment of the present subject matter. In order to compute the value realization index, the system 102 may receive from a user, a first input data indicative of a monetary value invested by the user on each of the one or more Information Technology (IT) services. Further, the system 102 may receive a second input data indicative of one or more computational weights for one or more qualities associated with the one or more Information Technology (IT) services from the user. Additionally, the system 102 may receive a third input data indicative of a second set of computational weights, transaction volume and cost associated with one or more business metrics of the one or more qualities. The system 102 may normalize the one or more computational weights at a level of the organization to generate one or more normalized computational weights for the one or more qualities. Further, the system 102 may capture one or more quality metrics for the one or more qualities and one or more business metrics for the one or more Information Technology (IT) services. The system 102 may map the one or more quality metrics with the one or more business metrics by considering the one or more normalized computational weights, the third input data and domain benchmark values. The system 102 may then identify scope for improvement for each of the one or more qualities based on said mapping in a manner such that, the scope for improvement identified exploits one or more business opportunities to the organization. The system 102 may validate the one or more business opportunities exploited in context of the scope for improvement identified based on said mapping. The system 102 may derive a business value for the organization based on the one or more opportunities exploited in context of the scope for improvement identified for each of the one or more qualities. The system 102 may then compute the value realization index for the one or more Information Technology (IT) services at a level of at least one of the user and the organization. The system 102 may compute the value realization index based on the business value derived and the first input data received from the user.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a network server and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 may be communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network may represent an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

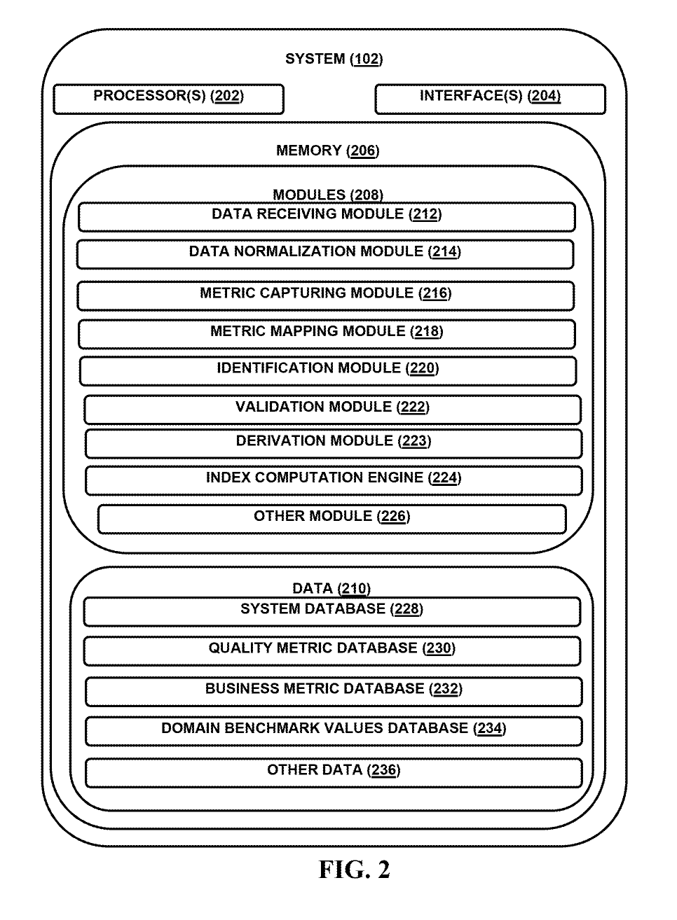

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, etc., which perform particular tasks or implement particular abstract data types. In one implementation, the modules 208 may include a data receiving module 212, a data normalization module 214, a metric capturing module 216, a metric mapping module 218, an identification module 220, a validation module 222, a derivation module 223, an index computation engine 224 and other module 226. The other module 226 may include programs or coded instructions that supplement applications and functions of the system 102.

The data 210, amongst other things, may serve as a repository for storing data processed, received, and generated by one or more of the modules 208. The data 210 may include a system database 228, a quality metric database 230, a business metric database 232, a domain benchmark values database 234 and other data 236. The other data 236 may include data generated as a result of the execution of one or more modules in the other module 218.

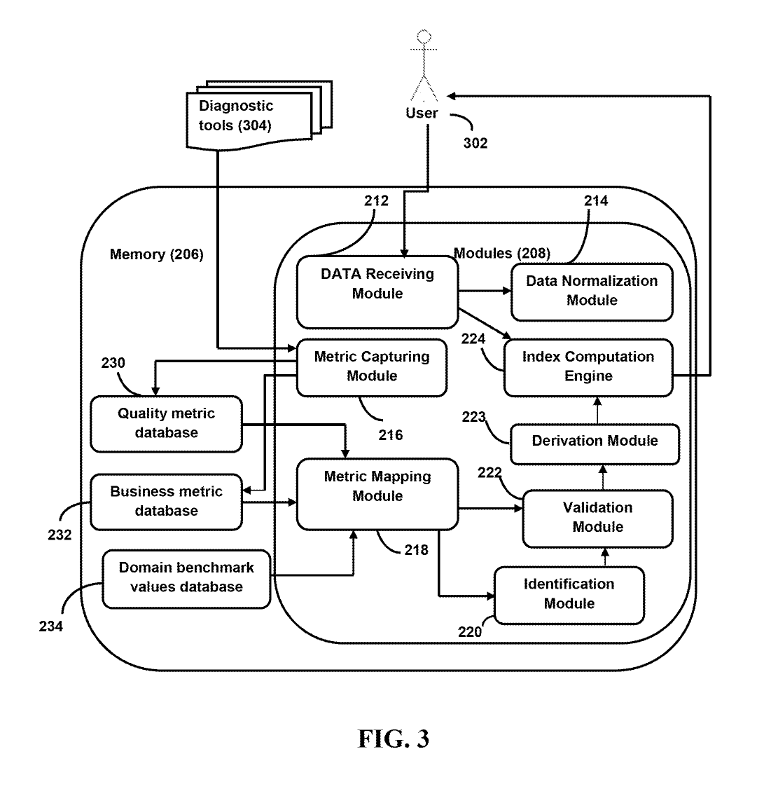

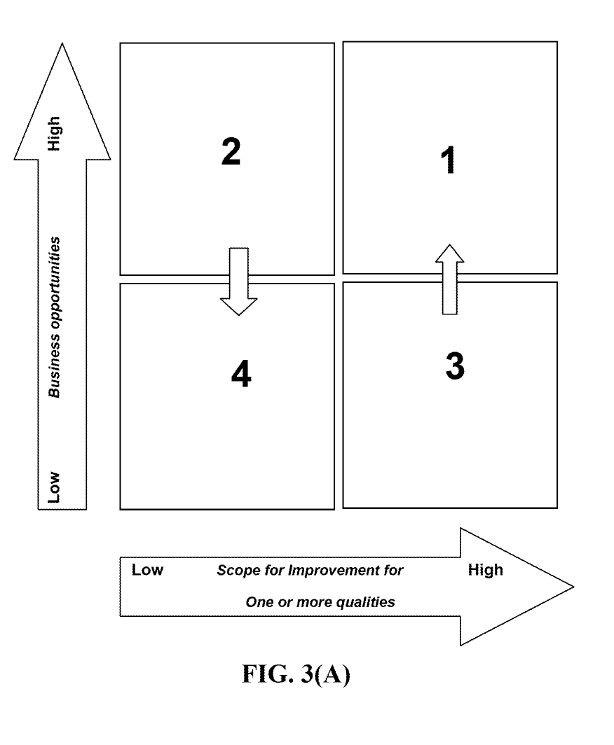

In one implementation, at first, a user may use at least one of the user devices 104 to access the system 102 via the I/O interface 204. The user may register using the I/O interface 204 in order to use the system 102. The working of the system 102 will be explained in detail with reference to FIG. 3 below. The system 102 may be used for computing the value realization index for the one or more IT Services.

Referring to FIG. 3, a detailed working of the components of the system 102 along is illustrated, in accordance with an embodiment of the present subject matter. The system 102 may be configured for computing a value realization index for one or more IT services, wherein the one or more IT services may be deployed in a framework located in an IT-enabled organization, preferably at the customer location. As illustrated, a user 302 may connect with the system 102. The user 302 may comprise at least one of a software developer, a team leader, a module lead, a team manager, delivery head, and a customer itself. In one embodiment, the one or more IT services comprise may comprise at least one of Application Development, Application Maintenance, Business Process Outsourcing, IT consulting and combinations thereof.

In one implementation, the data receiving module 212 may be configured to receive a first input data indicative of a monetary value invested by the user on each of the one or more Information Technology (IT) services. Further, the data receiving module 212 may be configured to receive a second input data indicative of one or more computational weights associated with one or more qualities of the one or more IT services. Additionally, the data receiving module 212 may be configured to receive a third input data indicative of a second set of computational weights, transaction volume and cost associated with one or more business metrics of the one or more qualities. In one embodiment, the first input data, the second input data and the third input data may be received from a user. Alternatively, the first input data, the second input data and the third input data may be received from a plurality of users. The plurality of users may collectively form an organizational hierarchy of the organization. The organizational hierarchy may include the higher management personals, team managers, team leads and associates. In one embodiment, the user may form an integral part of the organizational hierarchy. Similarly, the one or more IT services may be hierarchically represented in a manner such that each IT service further comprises a sub-service, and the sub-service further comprises another sub-service. In one example, the one or more IT services may be associated with the software development services, application maintenance services, consulting services and outsourcing services. In one embodiment, the one or more qualities comprise reliability, performance, availability, efficiency, compatibility, maintainability, transferability, suitability and one or more sub-qualities of each of the one or more qualities of the one or more IT services. The one or more qualities may be hierarchically represented in a manner such that each quality further comprises a sub-quality; the sub-quality further comprises another sub-quality. In one implementation, the computational weights may be indicative of priorities assigned to each of the qualities depending on the business needs of the organization. The computational weights may be directly associated with the perception of the user 302. More specifically the computational weights may be directly associated with the users' perception of prioritizing the one or more qualities. In one embodiment, the computational weights received from the user 302 may be in form of a percentage value depicting the priority of each of the one or more qualities. In one example, the user may assign a computational weight of 25% to a performance quality, 35% to a reliability quality and 40% to an efficiency quality. In another example, the user may assign a computational weight of 40% to the performance quality, 25% to the reliability quality and 35% to the efficiency quality. The one or more computational weights received from the user 302 may be stored in the system database 228. The organization implementing the one or more IT services may have different priorities and perceptions. Therefore, each of the computational weights received from the user 302 may have to be normalized as per the expectations or priorities of the organizational hierarchy. A data normalization module 214 may be configured for normalizing the one or more computational weights to a level of the organization. More specifically, the one or more computational weights may be normalized as per the expectations of the organization. For example, at the level of the organization, the data normalization module 214 may normalize the computational weights to generate normalized computational weights of 40%, 25% and 35% for the performance quality, the reliability quality and the efficiency quality respectively. The data normalization module 214 may generate the normalized computational weights in a manner such that, the summation of the one or more normalized computational weights may be hundred. The one or more normalized computational weights may be stored in the system database 228.

In one implementation, a metric capturing module 216 may be configured to capture one or more quality metrics associated with the one or more qualities of the one or more IT services. The metrics capturing module may capture the one or more quality metrics using external diagnostic tools 304. In one example, the one or more quality metrics may comprises throughput, response time, mean response time, Mean Turn-around Time, CPU Utilization, Memory Utilization, Mean time between failures (MTBF), User support function consistency and Hardware environmental adaptability. Further, the metrics capturing module 216 may be configured to capture the one or more quality metrics at three levels namely a current quality (Qc), a promised quality (Qp) and an actual delivered quality (Qd). The current quality (Qc), the promised quality (Qp) and the actual delivered quality (Qd) may be indicative of the current quality, the promised quality and the actual delivered quality for at least one of the one or more IT services. The data of one or more quality metrics may be stored in the quality metric database 230.

In one embodiment, the metric capturing module 216 may be configured to capture one or more business metrics associated with the one or more IT services. In one example, the one or more business metrics may comprise employee cost, infrastructure cost, and profit margin. Depending on the business requirements and the expectations of the organization, the one or more business metrics may be designed. The one or more business metrics may be stored in the business metric database 232. In one embodiment, the one or more quality metrics may be mapped with the one or more business metrics using the metric mapping module 218. The metric mapping module may utilize the normalized computational weights stored in the system database 228, the third input data and a domain benchmark values associated with the IT services stored in the domain benchmark values database 234. In one example, the domain benchmark values may comprises at least one of cost, effort, revenue, profit margin, resources and net sales, market share, industry understanding, policy and regulation impacting the business performance, competition, and emerging business models driven by new technologies.

In one embodiment, the current quality, the promised quality and the actual delivered quality for the one or more qualities may be analyzed to identify a scope for improvement for the one or more qualities of the one or more IT services. For example, a “performance” quality has a current quality, a promised quality and an actual delivered quality of 60%, 80% and 90% respectively; there is a scope for improvement of about 10%, considering 100% as an overall quality for the “performance” quality. Similarly, for the other qualities of the one or more IT services, the scope for improvement may be identified. In one embodiment, the scope for improvement may be identified only for those qualities that may exploit one or more business opportunities to the organization. For example, based on the domain benchmark values and the business metrics, the identification module 220 may identify only few of the one or more qualities of the IT services that may result in exploiting the one or more business opportunities to the organization. For example, the identification module 220 may analyze the scope for improvement identified as 10% for the “performance” quality using the domain benchmark values to ensure that the 10% improvement exploits the one or more business opportunities. For example, considering an IT service comprising a module for shipping orders received by a Point of Sale (POS) terminal, then the scope for improvement of 10% identified for the “performance” quality may have generate an additional 15 shipping orders. Alternatively, there may be instances, wherein a scope for improvement may be indentified for a specific quality; however, the scope for improvement may not result in exploiting the one or more business opportunities. Such qualities may be pushed down in the priority list for improvement by the identification module 220. Similar analysis may be performed by the identification module for identifying the scope for improvement for each of the one or more qualities, such that the scope for improvement identified exploits the one or more business opportunities. Further, the identification of the scope for improvement of the one or more qualities may be validated by the validation module 222. The validation module 222 may ensure that each of the qualities for which the scope for improvement is identified exploits the one or more business opportunities to the organization. The validation module may utilize the business metrics from the business metric database 232 and the domain benchmark values from the domain benchmark values database 234 for validation of the scope for improvement for each of the one or more qualities.

The metric mapping module may then implement a quadrant-based method for obtaining new priorities of the one or more qualities based on the normalized computational weights, the scope for improvement identified and the one or more business opportunities exploited. In order to enable this, the quadrant-based method may include the one or more business opportunities exploited for each of the one or more qualities on Y-Axis and the scope for improvement identified for each of the one or more qualities on X-Axis. Referring to FIG. 3 (A) is one such illustrative example of quadrant-based method implementation for determining the new priorities for the one or more qualities based on the scope for improvement identified and the one or more business opportunities.

As illustrated in FIG. 3(A), each of the one or more qualities may be represented in one of the four quadrants depending on the one or more business opportunities and the scope for improvement of each of the one or more qualities. In this illustrative example, the one or more qualities being placed in the quadrant II and the quadrant III have been shifted to the quadrant IV and the quadrant I respectively as a result of the scope for improvement identified. Thus, the metric mapping module 216 in association with the identification module 218 and the validation module is configured to map the quality metrics with the business metrics and indentifies the scope for improvement for each of the one or more qualities. The quadrant-based method implementation enables shifting of the priorities of the one or more qualities based on the scope for improvement identified for each of the one or more qualities of the one or more IT services.

In one embodiment, based on the scope for improvement identified, the one or more business opportunities exploited, and the new prioritization of the one or more qualities, the derivation module 223 may be configured for deriving a business value. Specifically, the derivation module 223 may derive the business value based on the one or more business opportunities exploited in context of the scope for improvement identified for each of the one or more qualities. For example, considering the above mentioned scenario, the scope for improvement of 10% identified for the “performance” quality, and thereby generating an additional 15 shipping orders may result in derivation of the business value as additional revenue. Each of the one or more qualities may contribute to the business value. In one embodiment, the business value can be derived for a hierarchy of business units or a hierarchy of line of businesses (LOBs). The business value may be considered as a cumulative factor that is derived based on cumulative contribution of each of the one or more qualities for each of the business units in the hierarchy of business units or each of the LOBs in the hierarchy of line of businesses (LOBs). The business value attributes the business volume and business cost per unit.

In an embodiment, the index computation engine 224 may be configured to compute the value realization index for the one or more IT services. The index computation engine 224 may compute the value realization index based on the business value derived and the first input data received from the user. Specifically, the value realization index may be computed as a ratio of the first input data received from the user and the business value derived by the system 102. In one embodiment, when the value realization is computed at the level of the user, the first input data may be the monetary value invested by the user. Alternatively, when the value realization index is computed at the level of the organization, the first input data may be an aggregation of the monetary values invested by the organizational hierarchy. Thus, the system 102 may be adapted to compute the value realization index for both the user and the organization. Thus, the value realization index may be referred to a quantifying value that indicates the business value derived by at least one of the user and the organization in relative to the monetary value invested by the user and the organization respectively on each of the one or more Information Technology (IT) services.

Exemplary embodiments discussed above may provide certain advantages. Though not required to practice aspects of the disclosure, these advantages may include:

The present disclosure may allow translating the aspects of the qualities of IT services into a quantifying value.

The present disclosure may enable aligning of the one or more quality metrics of the one or more qualities with the business metrics.

The present disclosure may enable normalizing the perceptions or the expectations of the user to the level of the organization, such that it derives value to the organization and is acceptable and appreciable in a systemic and systematic way to the user.

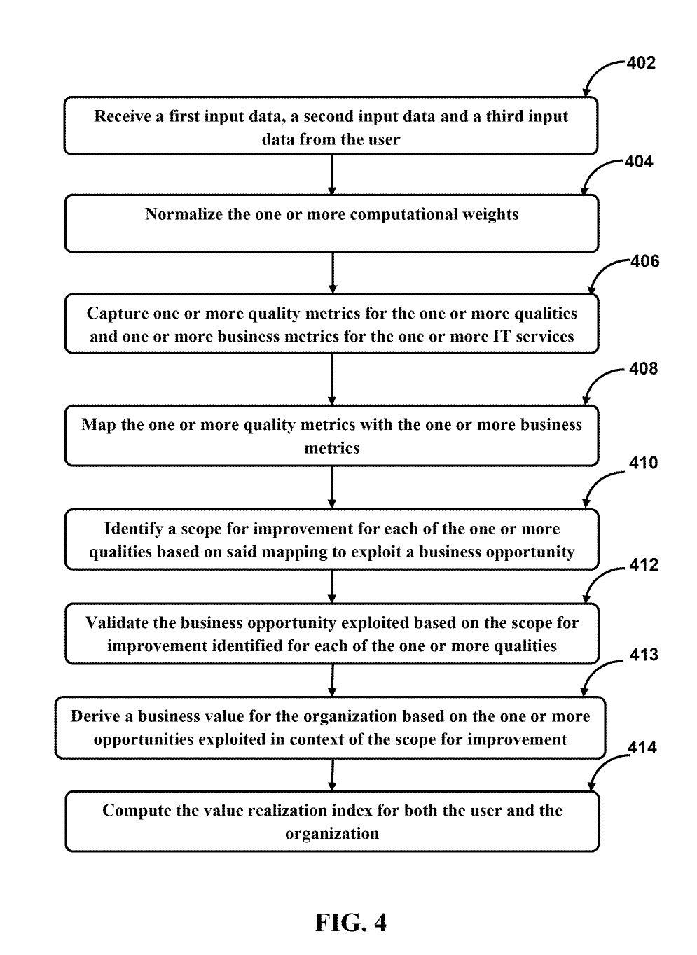

Referring now to FIG. 4, a method for computing a value realization index for one or more Information Technology (IT) services is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through the communications network 106. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, a first input data indicative of a monetary value invested by a user, a second input data indicative of one or more computational weights for one or more qualities associated with the one or more Information Technology (IT) services and the third input data indicative of a second set of computational weights, transaction volume and cost associated with one or more business metrics of the one or more qualities may be received from the user. The first input data, the second input data and the third input data may be stored in the system database 228. In one implementation, the first input data, the second input data and the third input data may be received by the data receiving module 212.

At block 404, the one or more computational weights may be normalized at a level of the organization to generate one or more normalized computational weights for the one or more qualities. The one or more normalized computational weights may be stored in the system database 228. In one implementation, the one or more computational weights may be normalized by the data normalization module 214.

At block 406, one or more quality metrics for the one or more qualities and one or more business metrics for the one or more Information Technology (IT) services may be captured. The one or more quality metrics may be stored in the quality metric database 230 and the one or more business metrics may be stored in the business metric database 232. In one implementation, the one or more quality metrics and the one or more business metrics may be captured by the metric capturing module 216.

At block 408, the one or more quality metrics may be mapped with the one or more business metrics by considering the one or more normalized computational weights, the third input data and domain benchmark values. In one implementation, the mapping may be performed by the metric mapping module 218.

At block 410, scope for improvement for each of the one or more qualities may be identified in a manner such that, the scope for improvement identified exploits one or more business opportunities to the organization. In one implementation, the scope for improvement for each of the one or more qualities may be identified by the identification module 220.

At block 412, the one or more business opportunities exploited in context of the scope for improvement identified based on said mapping may be validated. In one implementation, the validation may be performed by the validation module 222.

At block 413, a business value is derived for the organization based on the one or more opportunities exploited in context of the scope for improvement identified for the one or more qualities. In one implementation, the derivation may be performed by the derivation module 223.

At block 414, the value realization index for the one or more Information Technology (IT) services may be computed. In one implementation, the value realization index may be computed by the index computation engine 224. The value realization index is computed based on the business value derived and the first input data received from the user. The value realization index is computed at level of at least one of the user and the organization.

Although implementations for methods and systems for computing a value realization index for one or more Information Technology (IT) services have been described in language specific to structural features and/or methods, it is to be understood that the appended claims are not necessarily limited to the specific features or methods described. Rather, the specific features and methods are disclosed as examples of implementations for evaluating the value of the IT services rendered by IT vendor to the client.

We claim:

1. A system for computing a value realization index for one or more Information Technology (IT) services, wherein the IT services are implemented in a framework deployed at an organization, the system comprising:
a processor; and
a memory coupled to the processor, wherein the processor is capable of executing a plurality of modules stored in the memory, and wherein the plurality of modules include:
a data receiving module configured to receive from a user:
a first input data indicative of a monetary value invested by the user on each of the one or more IT services,
a second input data indicative of one or more computational weights for one or more qualities associated with the one or more IT services; and
a third input data indicative of a second set of computational weights, transaction volume and cost associated with one or more business metrics of the one or more qualities;
a data normalization module configured to normalize the one or more computational weights at a level of the organization to generate one or more normalized computational weights for the one or more qualities;
a metric capturing module configured to capture one or more quality metrics for the one or more qualities and one or more business metrics for the one or more IT services;
a metric mapping module configured to map the one or more quality metrics with the one or more business metrics by considering the one or more normalized computational weights, the third input data and domain benchmark values;
an identification module configured to identify scope for improvement for each of the one or more qualities based on said mapping in a manner such that the scope for improvement identified exploits one or more business opportunities to the organization;
a validation module configured to validate the one or more business opportunities exploited in context of the scope for improvement identified based on said mapping;
a derivation module configured to drive a business value for the organization based on the one or more opportunities exploited in context of the scope for improvement identified; and
an index computation engine configured to compute the value realization index for the one or more IT services at a level of at least one of the user and the organization, wherein the value realization index is computed based on the business value derived and the first input data received from the user.

2. The system of claim 1, wherein the metric capturing module is communicatively coupled with a quality metric database configured to store the one or more quality metrics.

3. The system of claim 1, wherein the metric capturing module is communicatively coupled with a business metric database configured to store the one or more business metrics.

4. The system of claim 1, wherein the metric mapping module may be communicatively coupled with a domain benchmark values database configured to store the domain benchmark values.

5. A method for computing a value realization index for one or more Information Technology (IT) services, wherein the IT services are implemented in a framework deployed at an organization, the method comprising:
receiving, by a processor, from a user:
a first input data indicative of a monetary value invested by the user on each of the one or more IT services,
a second input data indicative of one or more computational weights for one or more qualities associated with the one or more Information Technology IT services; and
a third input data indicative of a second set of computational weights, transaction volume and cost associated with one or more business metrics of the one or more qualities;
normalizing, by the processor, the one or more computational weights at a level of the organization to generate one or more normalized computational weights for the one or more qualities;
capturing, by the processor, one or more quality metrics for the one or more qualities and one or more business metrics for the one or more IT services;
mapping, by the processor, the one or more quality metrics with the one or more business metrics by considering the one or more normalized computational weights, the third input data and domain benchmark values;
identifying, by the processor, scope for improvement for each of the one or more qualities based on said mapping in a manner such that the scope for improvement identified exploits one or more business opportunities to the organization;
validating, by the processor, the one or more business opportunities exploited in context of the scope for improvement identified based on said mapping;
deriving a business value for the organization based on the one or more opportunities exploited in context of the scope for improvement identified; and
computing, by the processor, the value realization index for the one or more IT services at a level of at least one of the user and the organization, wherein the value realization index is computed based on the business value derived and the first input data received from the user.

6. The method of claim 5, wherein the one or more qualities comprise reliability, performance, availability, efficiency, compatibility, maintainability, transferability, suitability and one or more sub-qualities.

7. The method of claim 5, wherein the normalized computational weights are acceptable to the user for implementing the one or more IT services in the framework, and wherein the framework is an IT enabled framework.

8. The method of claim 5, wherein the one or more quality metrics are associated with a current quality, a promised quality and an actual delivered quality for each of the one or more qualities, and wherein the one or more quality metrics comprises throughput, response time, mean response time, mean turn-around time, CPU utilization, memory utilization, mean time between failures (MTBF), user support function consistency and hardware environmental adaptability.

9. The method of claim 8, wherein the current quality, the promised quality and the actual delivered quality is analyzed for identifying the scope of improvement for each of the one or more qualities of the one or more IT services.

10. The method of claim 5, wherein the domain benchmark values comprises at least one of cost, effort, revenue, profit margin, resources and net sales, market trend and industry understanding, policy and regulation impacting the business performance, competition, and emerging business models driven by new technologies.

11. The method of claim 5, wherein the user comprises at least one of a client, a software developer, a team leader, a module lead, a team manager, a delivery head, and a CEO.

12. A computer program product having embodied thereon a computer program for computing a value realization index for one or more Information Technology (IT) services, wherein the IT services are implemented in a framework deployed at an organization, the computer program product comprising:
a program code for receiving from a user:
a first input data indicative of a monetary value invested by the user on each of the one or more IT services,
a second input data indicative of one or more computational weights for one or more qualities associated with the one or more IT services, and
a third input data indicative of a second set of computational weights, transaction volume and cost associated with one or more business metrics of the one or more qualities;
a program code for normalizing the one or more computational weights at a level of the organization to generate one or more normalized computational weights for the one or more qualities;
a program code for capturing one or more quality metrics for the one or more qualities and one or more business metrics for the one or more IT services;
a program code for mapping the one or more quality metrics with the one or more business metrics by considering the one or more normalized computational weights and domain benchmark values;
a program code for identifying scope for improvement for each of the one or more qualities based on said mapping in a manner such that, the scope for improvement identified exploits one or more business opportunities to the organization;
a program code for validating the one or more business opportunities exploited in context of the scope for improvement identified based on said mapping;
a program code for deriving a business value for the organization based on the one or more opportunities exploited in context of the scope for improvement identified; and
a program code for computing the value realization index for the one or more IT services at a level of at least one of the user and the organization, wherein the value realization index is computed based on the business value derived and the first input data received from the user.
